(19) United States
(12) Patent Application Publication
(10) Pub. No.: US 2020/0241327 A1
(43) Pub. Date: Jul. 30, 2020

(54) WEARABLE APPARATUS AND SYSTEM FOR ALLEVIATING COMPUTER VISION SYNDROME INCLUDING THE SAME

(71) Applicant: Korea University Of Technology And Education Industry-University Cooperation Foundation, Cheonan-si (KR)

(72) Inventors: Seungwoo KANG, Cheonan-si (KR); Euihyeok LEE, Cheonan-si (KR); Chulhong MIN, Seoul (KR)

(73) Assignee: Korea University Of Technology And Education Industry-University Cooperation Foundation, Cheonan-si (KR)

(21) Appl. No.: 16/700,242

(22) Filed: Dec. 2, 2019

(30) Foreign Application Priority Data
Jan. 28, 2019 (KR) 10-2019-0010406

(51) Int. Cl. G02C 7/10; G02C 11/00; G01P 15/02; G01J 3/46

(52) U.S. Cl. CPC G02C 7/104; G01J 3/46; G01P 15/02; G02C 11/10

(57) ABSTRACT

A wearable apparatus includes a plurality of sensors, a plurality of actuators and a controller. The plurality of sensors is configured to sense a user's screen viewing activity. The plurality of actuators is configured to provide a plurality of feedbacks to the user according to the sensed user's screen viewing activity. The controller is configured to receive sensed data from the sensors and configured to operate the actuators based on the received sensed data.

### PRIORITY STATEMENT

This application claims priority under 35 U.S.C. § 119 to Korean Patent Application No. 10-2019-0010406, filed on Jan. 28, 2019 in the Korean Intellectual Property Office (KIPO), the contents of which are herein incorporated by reference in their entireties.

### BACKGROUND

### 1. Technical Field

Example embodiments relate to a wearable apparatus and a system for alleviating a computer vision syndrome. More particularly, example embodiments relate to a wearable apparatus monitoring user's screen viewing activities and providing real-time feedback to help the user take appropriate actions and a system for alleviating a computer vision syndrome.

### 2. Description of the Related Art

Digital screens are ubiquitous and indispensable in our lives, but the digital screens are like a double-edged sword. A user benefits from the digital screens for productivity, entertainment, information, etc. At the same time, the user's eyes may be hurt by the digital screens.

The prolonged use of the digital screens such as computers and smartphones may cause various symptoms such as eyestrain, dry eyes, blurred vision and neck and shoulder pain, referred to as computer vision syndrome (“CVS”).

### SUMMARY

Example embodiments provide a wearable apparatus monitoring user's screen viewing activities and providing real-time feedback to help the user take appropriate actions.

Example embodiments also provide a system for alleviating computer vision syndrome including the wearable apparatus.

In an example wearable apparatus according to the present inventive concept, the wearable apparatus includes a plurality of sensors, a plurality of actuators and a controller. The plurality of sensors is configured to sense a user's screen viewing activity. The plurality of actuators is configured to provide a plurality of feedbacks to the user according to the sensed user's screen viewing activity. The controller is configured to receive sensed data including the sensed user's screen viewing activity from the plurality of sensors and configured to operate the plurality of actuators based on the received sensed data.

In an example embodiment, the controller may include a sensor manager configured to receive the plurality of sensed data from the sensors and configured to extract a feature from the received sensed data, an actuator manager configured to control operations of the actuators based on the received sensed data, a screen viewing detector configured to detect whether the user is viewing a screen or not based on the received sensed data and an eye-resting detector configured to measure a viewing distance of the user based on the received sensed data to determine whether the viewing distance of the user is equal to or greater than a reference viewing distance in an eye-resting session.

In an example embodiment, the screen viewing detector may be configured to operate a multi-sensory fusion operation using the received sensed data received from the plurality of sensors.

In an example embodiment, the wearable apparatus may further include a database configured to store the user's screen viewing activity.

In an example embodiment, the plurality of sensors may include a color sensor, an inertial sensor and a distance measurement sensor.

In an example embodiment, the sensed data from at least two sensors among the color sensor, the inertial sensor and the distance measurement sensor may be combined.

In an example embodiment, the wearable apparatus may be configured to extract sensor specific features of the color sensor, the inertial sensor and the distance measurement sensor separately, to concatenate the sensor specific features in a feature level, to normalize the sensor specific features to standardize a range of the sensor specific features and to apply for a principal component analysis (PCA) to the normalized sensor specific features to reduce input dimensions. The wearable apparatus may be configured to use a support vector machine (SVM) as a unified classifier for the color sensor, the inertial sensor and the distance measurement sensor.

In an example embodiment, the plurality of actuators may include a vibrator and a light emitting element.

In an example embodiment, the plurality of actuators may operate in a first feedback mode, a second feedback mode and a third feedback mode.

In an example embodiment, the vibrator may be configured to operate in the first feedback mode. The light emitting element may be configured to generate a first color light and a second color light in the second feedback mode. The vibrator may be configured to operate in the third feedback mode. Vibration of the vibrator in the third feedback mode may be weaker than vibration of the vibrator in the first feedback mode

In an example system for alleviating computer vision syndrome according to the present inventive concept, the system includes a wearable apparatus and a mobile application. The mobile application is configured to provide a retrospective summary representing whether a user follows a 20-20-20 rule. The wearable apparatus includes a plurality of sensors, a plurality of actuators a controller. The plurality of sensors is configured to sense a user's screen viewing activity. The plurality of actuators is configured to provide a plurality of feedbacks to the user according to the sensed user's screen viewing activity. The controller is configured to receive sensed data including the sensed user's screen viewing activity from the plurality of sensors and configured to operate the actuators based on the received sensed data.

In an example embodiment, the mobile application may be configured to provide q user's daily screen viewing time, a user's weekly screen viewing time, a user's monthly screen viewing time and a user's yearly screen viewing time. The mobile application may be configured to provide a first number which is a number of screen viewing more than 20 minutes and a second number which is a number of taking a 20 second break to view objects 20 feet away following the 20-20-20 rule.

In an example wearable apparatus according to the present inventive concept, the wearable apparatus includes an eyeglass frame, a plurality of sensors disposed on the eyeglass frame, a plurality of actuators, disposed on the eyeglass frame and configured to provide a plurality of feedbacks and a processor disposed on the eyeglass frame and configured to control the plurality of sensors and the plurality of actuators.

In an example embodiment, the plurality of sensors may include a color sensor, an inertial sensor and a distance measurement sensor.

In an example embodiment, the color sensor and the distance measurement sensor may be disposed on a bridge of the eyeglass frame between a left lens and a right lens.

In an example embodiment, the actuators may include a vibrator and a light emitting element.

In an example embodiment, the vibrator may be disposed on temple of the eyeglass frame. The light emitting element may be disposed on a left lens rim or a right lens rim.

In an example system for alleviating computer vision syndrome according to the present inventive concept, the system includes a wearable apparatus and a mobile application. The mobile application is configured to provide a retrospective summary representing whether a user follows a 20-20-20 rule. The wearable apparatus includes an eyeglass frame, a plurality of sensors and disposed on the eyeglass frame, a plurality of actuators, disposed on the eyeglass frame and configured to provide a plurality of feedbacks and a processor disposed on the eyeglass frame and configured to control the plurality of sensors and the plurality of actuators.

According to the wearable apparatus and the system for alleviating computer vision syndrome including the wearable apparatus, the wearable apparatus senses the user's screen viewing activities and helping the user follow the 20-20-20 rule to alleviate the user's computer vision syndrome.

The wearable apparatus and the system for alleviating computer vision syndrome include a color sensor, an inertial sensor and a distance measurement sensor so that the user's screen viewing activities may be accurately monitored. In addition, the wearable apparatus and the system for alleviating computer vision syndrome may provide real-time feedback to help the user follow the 20-20-20 rule.

In addition, the system for alleviating computer vision syndrome may provide a retrospective summary which shows how well the user followed the 20-20-20 rule via a mobile application.

### BRIEF DESCRIPTION OF THE DRAWINGS

The above and other features and advantages of the present inventive concept will become more apparent by describing in detailed example embodiments thereof with reference to the accompanying drawings, in which:

FIG. 1 is a block diagram illustrating a wearable apparatus according to an example embodiment of the present inventive concept;

FIG. 2 is a perspective view illustrating a hardware prototype of the wearable apparatus of FIG. 1;

FIGS. 3 and 4 are screenshots of a mobile application included in a system for alleviating computer vision syndrome according to an example embodiment of the present inventive concept;

FIG. 5 is a block diagram illustrating a multi sensory fusion architecture of the wearable apparatus of FIG. 1;

FIG. 6A is a graph illustrating sensed data of a color sensor of FIG. 1 in web surfing situation on a desktop;

FIG. 6B is a graph illustrating sensed data of the color sensor of FIG. 1 when a user is watching video on a desktop;

FIG. 6C is a graph illustrating sensed data of the color sensor of FIG. 1 when the user is reading a book;

FIG. 6D is a graph illustrating sensed data of the color sensor of FIG. 1 when the user is taking a rest;

FIG. 7 is a table illustrating features of an inertial sensor and a distance measurement sensor of FIG. 1;

FIG. 8A is a graph illustrating accelerometer data of the inertial sensor of FIG. 1 in web surfing situation on a smartphone;

FIG. 8B is a graph illustrating accelerometer data of the inertial sensor of FIG. 1 in web surfing situation on a laptop;

FIG. 8C is a graph illustrating accelerometer data of the inertial sensor of FIG. 1 in web surfing situation the desktop;

FIG. 8D is a graph illustrating accelerometer data of the inertial sensor of FIG. 1 when the user is reading a book;

FIG. 9A is a graph illustrating sensed data of a distance measurement sensor of FIG. 1 when the user is watching video on the smartphone;

FIG. 9B is a graph illustrating sensed data of the distance measurement sensor of FIG. 1 when the user is watching video on the laptop;

FIG. 9C is a graph illustrating sensed data of the distance measurement sensor of FIG. 1 when the user is watching video on the desktop;

FIG. 9D is a graph illustrating sensed data of the distance measurement sensor of FIG. 1 when the user is reading a book;

FIG. 10 is a table illustrating a real distance between the user and an object, a measured distance between the user and the object measured by the distance measurement sensor of FIG. 1 and a difference between the real distance and the measured distance;

FIG. 11A is a graph illustrating perceptibility of a vibrator of FIG. 1;

FIG. 11B is a graph illustrating comfortability of the vibrator of FIG. 1;

FIG. 11C is a graph illustrating perceptibility of a LED of FIG. 1; and

FIG. 11D is a graph illustrating comfortability of the LED of FIG. 1.

### DETAILED DESCRIPTION OF THE EMBODIMENTS

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set fourth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

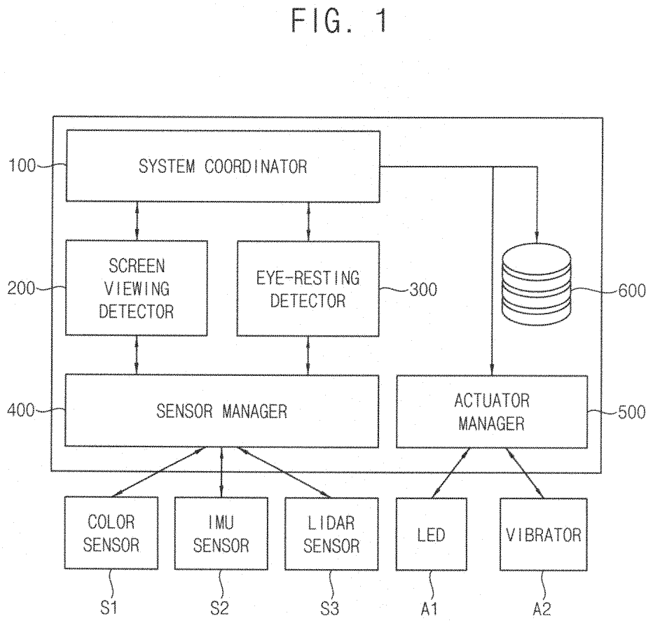

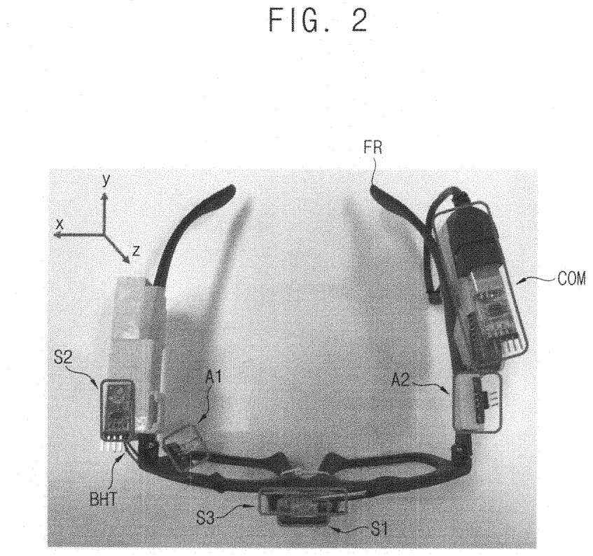

FIG. 1 is a block diagram illustrating a wearable apparatus according to an example embodiment of the present inventive concept. FIG. 2 is a perspective view illustrating a hardware prototype of the wearable apparatus of FIG. 1.

Referring to FIGS. 1 and 2, the wearable apparatus helps the user follow a 20-20-20 rule. The 20-20-20 rule is a strategy to alleviate the computer vision syndrome. The 20-20-20 rule suggests taking a 20 second break to view something 20 feet away every 20 minutes of screen use. The wearable apparatus operates following actions to help the user follow the 20-20-20 rule.

1) Integrated monitoring of screen viewing: To provide accurate notifications of the screen viewing, i.e., 20 minutes of screen viewing, the wearable apparatus may detect the user's screen viewing events in an integrated way across multiple screen-equipped devices such as a laptop, a tablet, and a smartphone.

2) Effective guidance of eye rest: For adequate eye rest, the wearable apparatus may guide the user to look at something 20 feet away for 20 seconds, beyond just stopping them from viewing the screen-equipped device.

3) Non-distracting notification: The wearable apparatus may avoid providing notifications via the screen-equipped devices as it could turn a user's attention into other digital contents. For example, using smartphone notifications to let users know when to stop viewing a laptop could lead them to use other mobile apps instead of taking a break.

Herein, the computer vision syndrome broadly includes symptoms due to the use of the screen-equipped device. The computer vision syndrome may not be limited to symptoms due to the desktop or the laptop.

For example, the wearable apparatus may be an eyeglasses type wearable apparatus. The eyeglasses type wearable apparatus may have unique advantages as it can directly track what the user sees. First, the eyeglasses type wearable apparatus may enable accurate, integrated monitoring of screen viewing activities regardless of the type and ownership of the devices, e.g., the laptop, the smartphone, and even shared tablet. Second, the eyeglasses type wearable apparatus may track the viewing distance during eye break, thereby guiding a user to adequately take a rest while seeing 20 feet away.

The wearable apparatus may be a standalone system. The wearable apparatus may run in various real-life situations even where a nearby powerful device such as the smartphone is unavailable. In addition, the wearable apparatus may provide non-distracting notifications without relying on other screen-equipped devices.

The primary goal of the wearable apparatus may assist the user in following the 20-20-20 rule in daily lives. The wearable apparatus may continuously monitor the user's screen viewing activities and may provide real-time feedback to help the user take appropriate actions depending on the situation.

The wearable apparatus may notify the user of 1) taking a break for the user's eyes if the user views a screen more than 20 minutes, 2) seeing 20 feet away if the user views nearby objects during a break, and 3) returning to the user's previous activity, e.g. working or studying, if the user takes a break for 20 seconds. If the user starts viewing the screen again without completing a 20 second break, the wearable apparatus may restart monitoring screen viewing activity and may record that the user does not follow the 20-20-20 rule.

FIG. 1 represents a system architecture of the wearable apparatus. The wearable apparatus includes a system coordinator 100, a screen viewing detector 200, an eye-resting detector 300, a sensor manager 400 and an actuator manager 500. The wearable apparatus may further include a database 600. The wearable apparatus may further include a plurality of sensors S1, S2 and S3 and a plurality of actuators A1 and A2. The system coordinator 100, the screen viewing detector 200, the eye-resting detector 300, the sensor manager 400 and the actuator manager 500 may form a controller. The controller may control the sensors S1, S2 and S3 and the actuators A1 and A2. For example, the actuators A1 and A2 may be included in a smartphone. For example, the smartphone may function as the actuators A1 and A2.

The system coordinator 100 controls an operation of the wearable apparatus. For example, the system coordinator 100 controls operations of the screen viewing detector 200, the eye-resting detector 300, the sensor manager 400 and the actuator manager 500.

A key component of the wearable apparatus may be the screen viewing detector 200, the eye-resting detector 300 and the actuator manager 500.

The screen viewing detector 200 detects if the user is viewing a screen or not. For the detection, the screen viewing detector 200 may adopt a multi sensory fusion approach with a plurality of sensors S1, S2 and S3. For example, the sensors S1, S2 and S3 may include a color sensor S1, an inertial sensor (IMU sensor) S2 and a distance measurement sensor (a lidar sensor) S3.

The sensors S1, S2 and S3 are controlled by the sensor manager 400. The sensor manager 400 may process sensed data received from the sensors S1, S2 and S3. The sensor manager 400 may operate the multi sensory fusion operation using the sensed data received from the sensors S1, S2 and S3.

The eye-resting detector 300 is triggered if the screen viewing event is detected for 20 minutes. The eye-resting detector 300 may measure a viewing distance of the user based on the sensed data to determine if the viewing distance of the user is equal to or greater than a reference viewing distance in an eye-resting session. The eye-resting detector 300 keeps measuring a viewing distance using the distance measurement sensor S3 to check if the user is seeing 20-feet away in the eye-resting session.

To provide realtime notification, the wearable apparatus may include two actuators A1 and A2. The actuators A1 and A2 may be a light emitting element (e.g. LED) A1 and a vibrator A2. The actuators A1 and A2 may be controlled by the actuator manager 500. The actuators A1 and A2 may be controlled to provide both for perceptibility and comfortability to the user. For example, the actuators A1 and A2 may be included in a smartphone. For example, the smartphone may function as the actuators A1 and A2.

FIG. 2 shows a hardware prototype of the wearable apparatus. As shown in FIG. 2, the main components of the hardware prototype may include the sensors S1, S2 and S3, a processing unit COM and the actuators A1 and A2. For example, the processing unit COM may include the system coordinator 100, the screen viewing detector 200, the eye-resting detector 300, the sensor manager 400 and the actuator manager 500.

For screen viewing and distance detection, the wearable apparatus may include the color sensor S1, the inertial sensor S2 and the distance measurement sensor S3. The color sensor S1 may be the RGB color sensor. The inertial sensor S2 may include a 3-axis accelerometer, a 3-axis gyroscope, and a 3-axis magnetometer. The distance measurement sensor S3 may be a Time of Flight type distance measurement sensor.

The wearable apparatus may include an eyeglasses frame FR. The sensor S1, S2 and S3, the processing unit COM and the actuators A1 and A2 may be coupled to the eyeglasses frame FR. The wearable apparatus may further include a battery BHT coupled to the eyeglasses frame FR.

The positions of the components may be properly disposed considering accurate sensing and effective feedback with avoiding positions which occlude the user's eyes. For example, the color sensor S1 and the distance measurement sensor S3 may be disposed on a bridge of the eyeglasses frame FR between a left lens and a right lens. The color sensor S1 and the distance measurement sensor S3 are disposed on the bridge of the eyeglasses frame FR to sense along the direction of viewing. For the light emitting element A1 and the vibrator A2 may be disposed where the user notices well the feedback while the user does not feel uncomfortable. For example, the vibrator A2 may be disposed on the bridge or a temple of the eyeglasses frame FR. When the vibrator A2 is disposed on the bridge, nose pads may vibrate so that the user may feel tickled. Preferably, the vibrator A2 may be disposed on the temple of the eyeglasses frame FR. The light emitting element A1 may be disposed adjacent to the right lens or the left lens toward the right lens or the left.

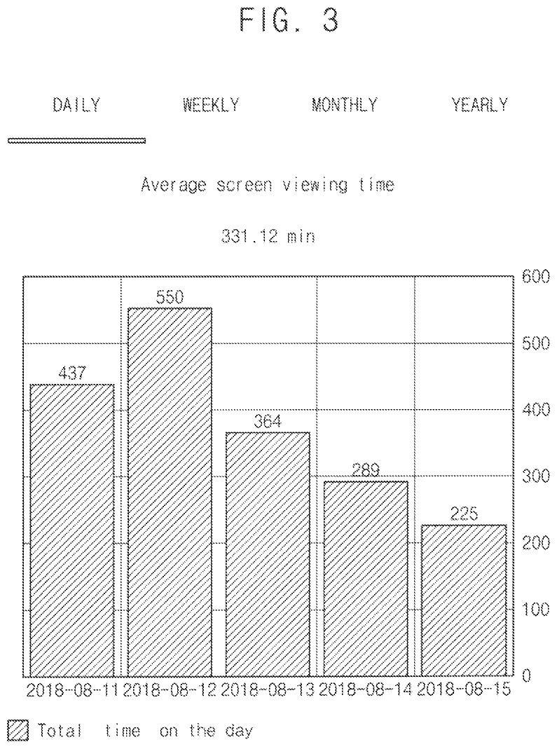

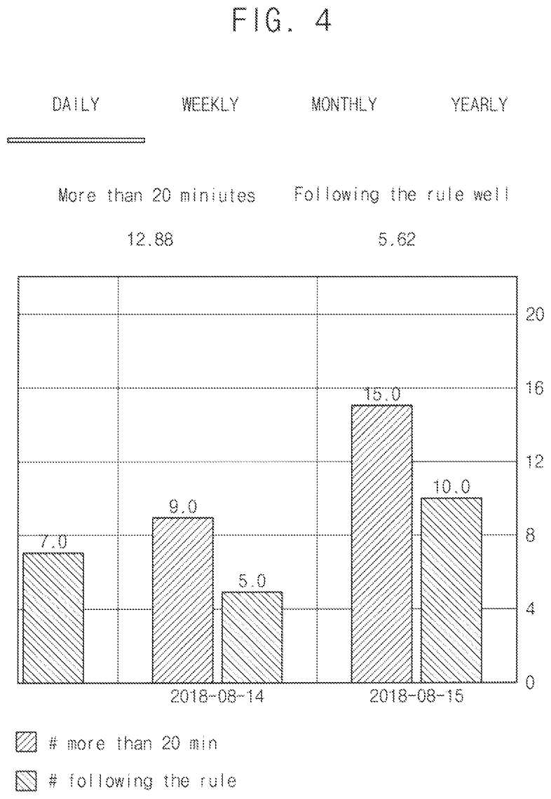

FIGS. 3 and 4 are screenshots of a mobile application included in a system for alleviating computer vision syndrome according to an example embodiment of the present inventive concept.

Referring to FIGS. 1 to 4, the system for alleviating the computer vision syndrome may include the wearable apparatus and the mobile application to provide a retrospective summary that shows how well the user followed the 20-20-20 rule. The detection results may be maintained in the database 600 and may be used to provide the retrospective summary.

In FIG. 3, the mobile application may provide a user's daily screen viewing time, a user's weekly screen viewing time, a user's monthly screen viewing time and a user's yearly screen viewing time.

In FIG. 4, the mobile application may provide a first number which means a number of screen viewing more than 20 minutes and a second number which means a number of taking a 20 second break to view something 20 feet away following the 20-20-20 rule. The mobile application may provide the daily, weekly, monthly and yearly first number and the daily, weekly, monthly and yearly second number.

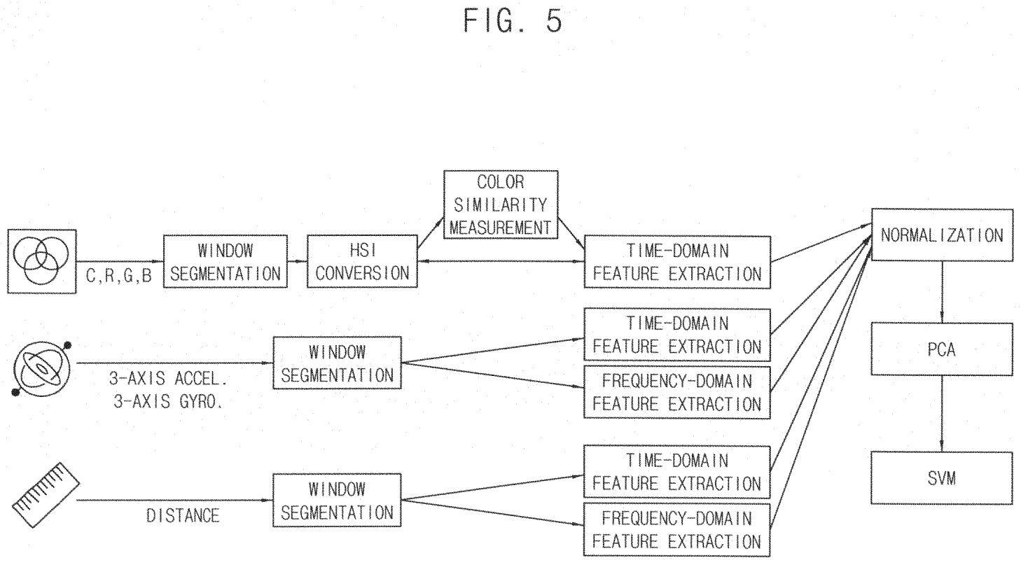

FIG. 5 is a block diagram illustrating a multi sensory fusion architecture of the wearable apparatus of FIG. 1.

Referring to FIGS. 1 to 5, the wearable apparatus may include the color sensor S1, the inertial sensor S2 and the distance measurement sensor S3 to accurately determine the user's screen viewing activities. The color sensor S1 senses an object being seen. The inertial sensor S2 senses the user's head movement. The distance measurement sensor S3 measures the user's viewing distance.

Each sensor S1, S2 and S3 is suitable to detect the screen viewing activities accurately, but is also vulnerable to false positive errors, i.e., incorrectly inferring a non-screen viewing activity as a screen viewing event. To address the challenge, we take a multi sensory fusion approach with three sensor modalities S1, S2 and S3.

FIG. 5 represents the overall architecture of the multi sensory fusion method. For the sensor fusion, the wearable apparatus may take an early fusion approach. For example, the wearable apparatus may extract sensor specific features of the sensors S1, S2 and S3 separately and concatenating the sensor specific features in a feature level. The wearable apparatus may normalize the features to standardize the range of features and then apply for a principal component analysis (PCA) to reduce the input dimensions. To maximize classification capability, the wearable apparatus may use a support vector machine (SVM) as a unified classifier for three sensors S1, S2 and S3, rather than simply taking a weighted sum of the classification from each sensor S1, S2 and S3.

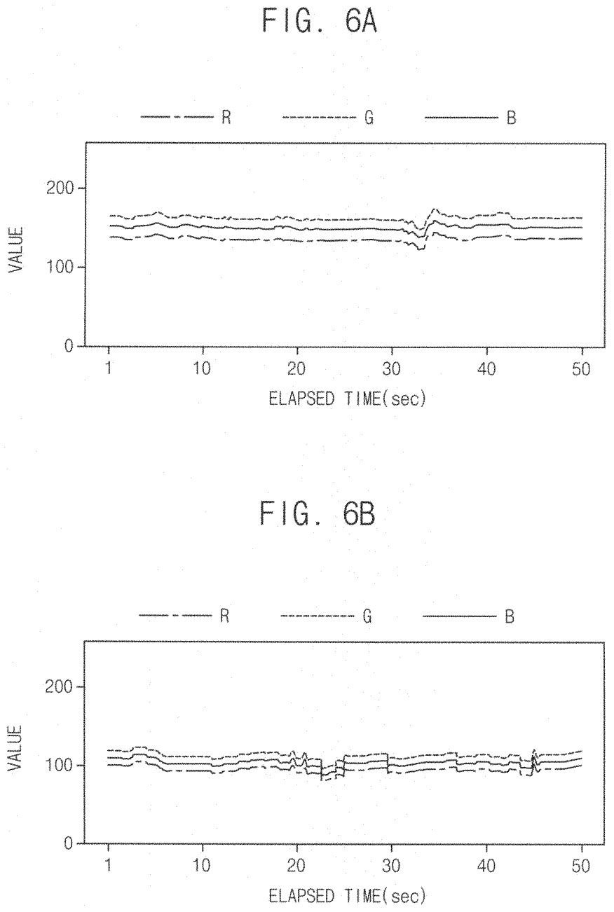

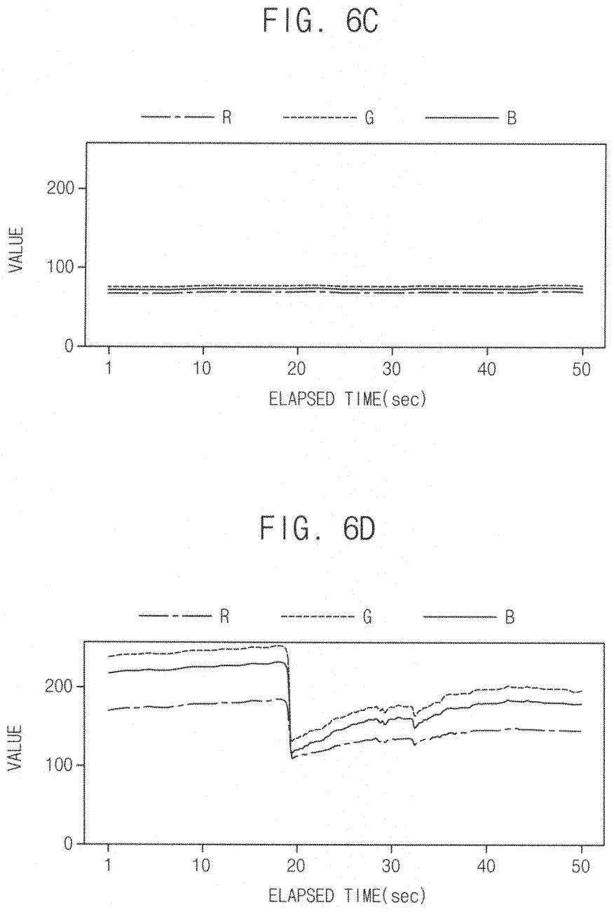

FIG. 6A is a graph illustrating sensed data of the color sensor S1 of FIG. 1 in web surfing situation on a desktop. FIG. 6B is a graph illustrating sensed data of the color sensor S1 of FIG. 1 when a user is watching video on a desktop. FIG. 6C is a graph illustrating sensed data of the color sensor S1 of FIG. 1 when the user is reading a book. FIG. 6D is a graph illustrating sensed data of the color sensor S1 of FIG. 1 when the user is taking a rest.

Referring to FIGS. 1 to 6D, the wearable apparatus may adopt the RGB color sensor S1 as an alternate of a camera. A key idea of using the color sensor S1 is to leverage the speed of changes in objects being seen. When the user views the screen, the user are mostly stationary and thus see similar scenes, i.e., objects being seen do not change much macroscopically. However, even in such situations, contents on the digital screen change relatively faster than non-screen objects being seen, e.g., when reading a book.

FIGS. 6a and 6b show the sensed data of the color sensor S1 when the user is surfing web and watching a video on a desktop, respectively. FIGS. 6C and 6D show the sensed data of the color sensor S1 when the user is reading a book and moving around, respectively. In the stationary situations (FIGS. 6A, 6B and 6C), the color signals are much stabler than when the user is moving (FIG. 6D). However, the variation of the data in the screen viewing (FIGS. 6A and 6B) is relatively larger than when a user reads a book (FIG. 6C).

The wearable apparatus may read RGB values at a predetermined interval and convert a color space into hue, saturation, and intensity (HSI). This is because an RGB space is known to be heavily biased by environmental factors such as shadows of objects and reflection of lights, but HSI is more robust to ambient factors so suitable to represent human visual characteristics.

In addition to HSI streams, the wearable apparatus may produce two more streams to compute the similarity of HSI samples within a window. First, the wearable apparatus may compute the distance between consecutive HSI samples, i.e., a list of distance(Xi, Xi+1), where distance( ) is a distance function and Xi is i-th HSI sample. Second, the wearable apparatus may compute the distance between all pairs of HSI samples in a window, i.e., a list of distance(Xi, Xj). Herein, j>i. Herein, the Euclidean distance may be used as a distance function.

From each stream, the wearable apparatus may compute mean, median, variance, range between 80th and 20th percentile, and root mean square. In a window, the wearable apparatus may extract 25 features in total.

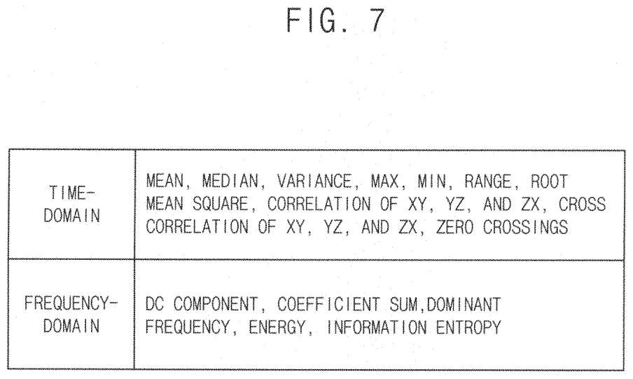

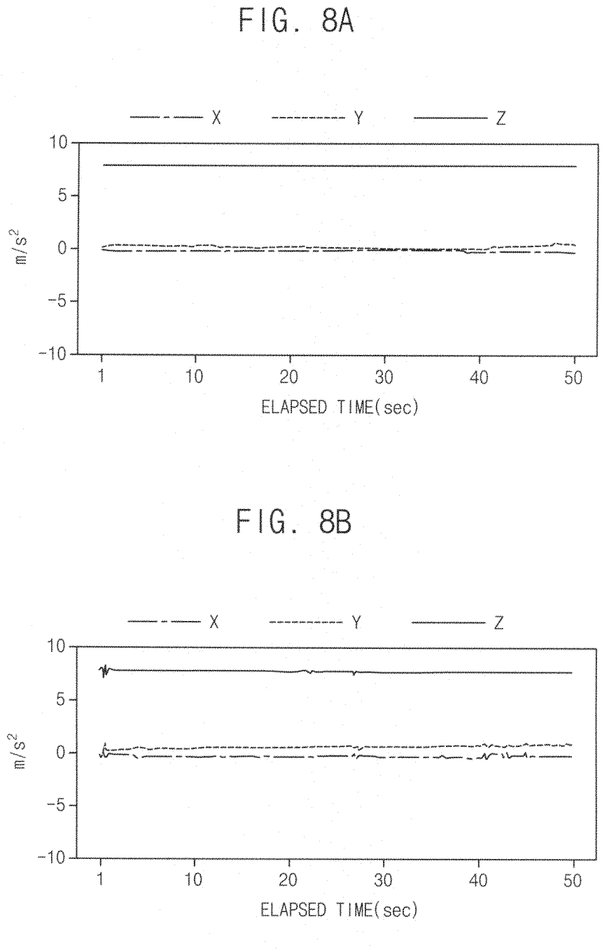

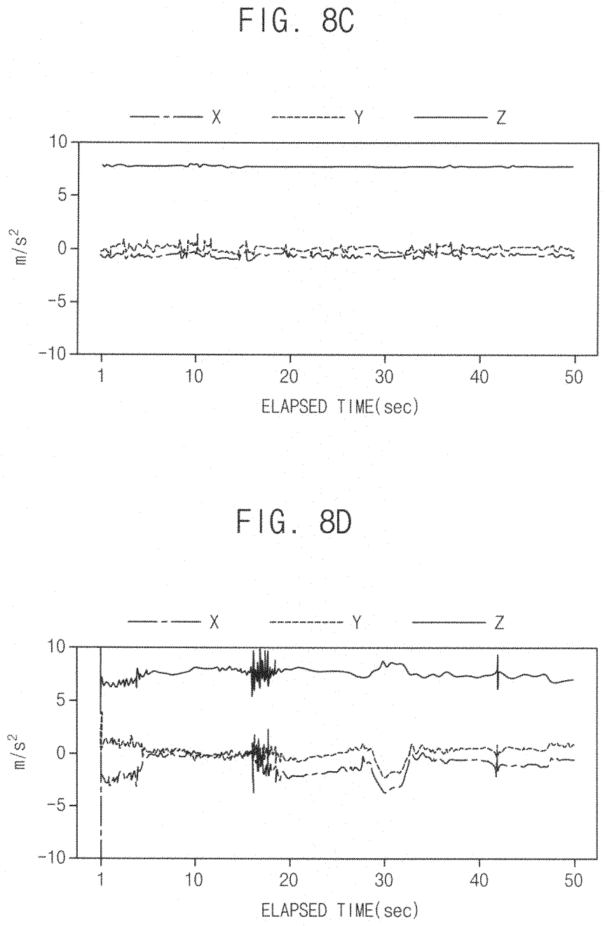

FIG. 7 is a table illustrating features of the inertial sensor S2 and the distance measurement sensor S3 of FIG. 1. FIG. 8A is a graph illustrating accelerometer data of the inertial sensor S2 of FIG. 1 in web surfing situation on a smartphone. FIG. 8B is a graph illustrating accelerometer data of the inertial sensor S2 of FIG. 1 in web surfing situation on a laptop. FIG. 8C is a graph illustrating accelerometer data of the inertial sensor S2 of FIG. 1 in web surfing situation the desktop. FIG. 8D is a graph illustrating accelerometer data of the inertial sensor S2 of FIG. 1 when the user is reading a book.

Referring to FIGS. 1 to 8D, the head movement can be suggestive of screen viewing activities. The users hardly move their head while viewing a screen. The typical examples are working on a laptop and watching a video on a smartphone. Also, the head orientation would be a clue to detect screen viewing. People mostly view the phone and laptop while lowering the head and view the desktop screen while lowering or raising the head a little. On the contrary, people usually have relatively larger head movement when they do not view the screen even in the stationary situations.

FIGS. 8A, 8B and 8C show the accelerometer traces when the user is surfing web on a smartphone, a laptop, and a desktop, respectively. FIG. 8D show the accelerometer traces when the user is reading a book on the desk. Herein, X-axis, Y-axis and Z-axis in FIGS. 8A to 8D may be equal to X-axis, Y-axis and Z-axis in FIG. 2. The values of Y-axis (user facing) are consistently higher than the values of X-axis (horizontal) because people usually lower their head to see something.

The wearable apparatus reads the sensed data from 3-axis accelerometer of the inertial sensor S2 and the sensed data from 3-axis gyroscope of the inertial sensor S2. Then, the wearable apparatus segments the stream into the windows and extracts time-domain and frequency-domain features.

FIG. 7 shows the list of the features used in the wearable apparatus. The wearable apparatus computes the same set of features for accelerometer and gyroscope separately and then concatenate the set of the features. From a window, the wearable apparatus may extract 38 features in total; 19 features from accelerometer and gyroscope each.

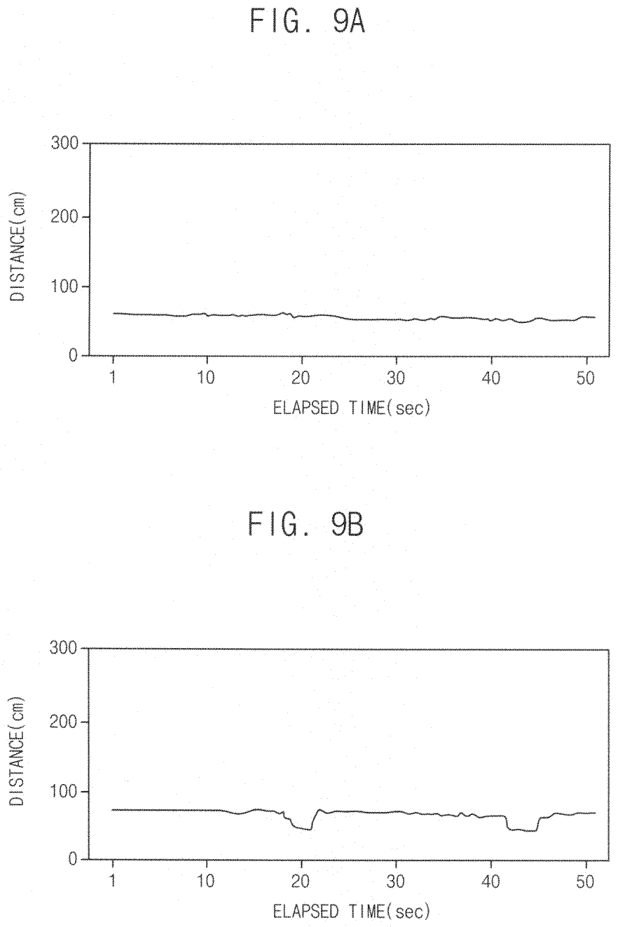

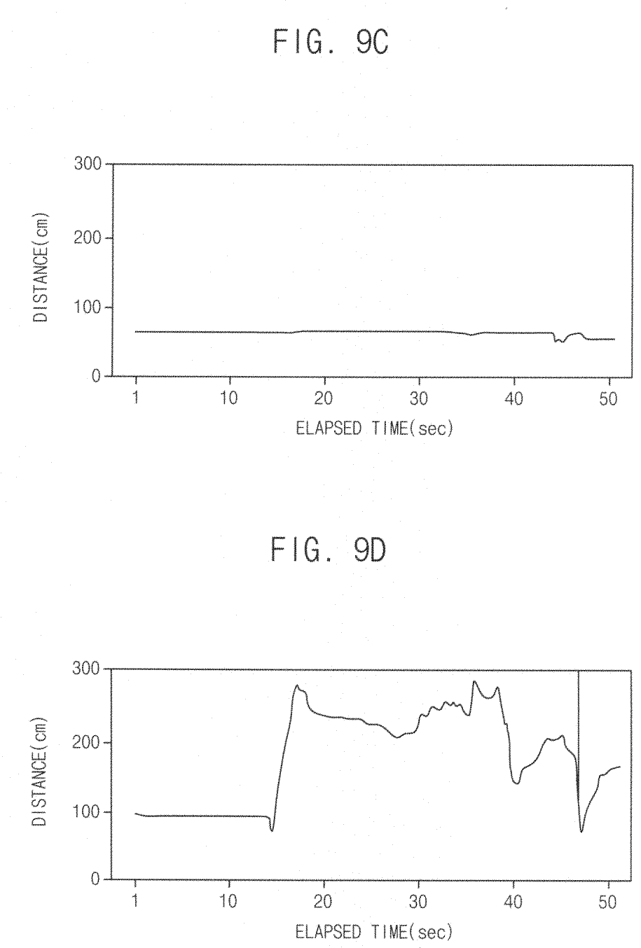

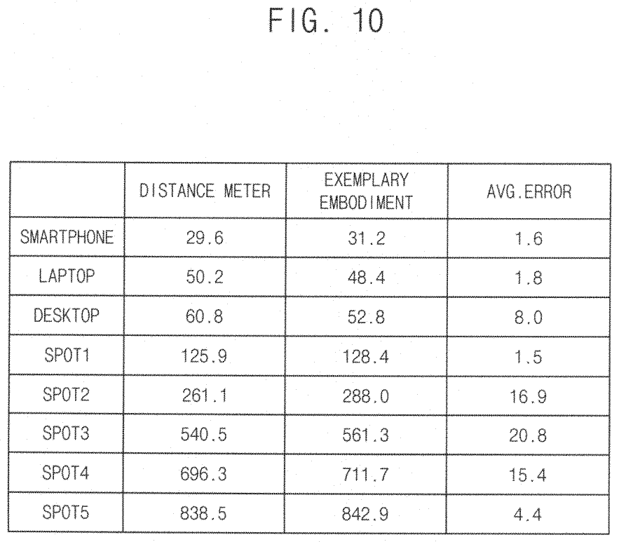

FIG. 9A is a graph illustrating sensed data of the distance measurement sensor S3 of FIG. 1 when the user is watching video on the smartphone. FIG. 9B is a graph illustrating sensed data of the distance measurement sensor S3 of FIG. 1 when the user is watching video on the laptop. FIG. 9C is a graph illustrating sensed data of the distance measurement sensor S3 of FIG. 1 when the user is watching video on the desktop. FIG. 9D is a graph illustrating sensed data of the distance measurement sensor S3 of FIG. 1 when the user is reading a book. FIG. 10 is a table illustrating a real distance between the user and an object, a measured distance between the user and the object measured by the distance measurement sensor S3 of FIG. 1 and a difference between the real distance and the measured distance.

Referring to FIGS. 1 to 10, people have typical viewing distance for digital devices. For example, people usually view a smartphone, a laptop, and a desktop at 18 to 60 cm away, 40 to 70 cm away, and 50 to 80 cm away. Viewing distance in such ranges does not guarantee the screen viewing activities, but the distance out of these ranges can ensure non-screen activities. FIGS. 9A, 9B and 9C show the distance trace measured by the distance measurement sensor S3 when the user is watching a video on smartphone, laptop, and desktop screen, respectively and FIG. 9D shows the distance trace measured by the distance measurement sensor S3 when the user is reading a book.

While the distance measurement sensor S3 provides the distance information directly, it is not easy to obtain the accurate distance to an object seen. Even the slight difference of angles between the pointing direction of the distance measurement sensor S3 and eye direction could result in a large error. The accurate measurement of viewing distance may be important and used for the eye-resting detection, i.e., detect if a user is seeing 20 feet away. Thus, the distance measurement sensor S3 may be disposed on the bridge of the eyeglasses frame FR between the left lens and the right lens.

FIG. 10 shows the distance measurement result of the wearable apparatus. The difference between a real distance between the user and an object and a measured distance between the user and the object measured by the distance measurement sensor S3 becomes larger as the viewing distance increases, but the error is not large, ranging from 1.5 cm to 20.8 cm. This error may be acceptable to the application of the wearable apparatus according to the present example embodiment.

The wearable apparatus reads the sensed data of the distance measurement sensor S3 at the maximum rate. The wearable apparatus extracts the features shown in FIG. 7 from the distance measurement sensor S3. Since changes in viewing distances also reflect head movement to some extent, so that the same set of features may be extracted from the inertial sensor S2 and the distance measurement sensor S3. 13 features may be extracted from the distance measurement sensor S3. For the eye-resting detection, the wearable apparatus may use an average of distance values every second.

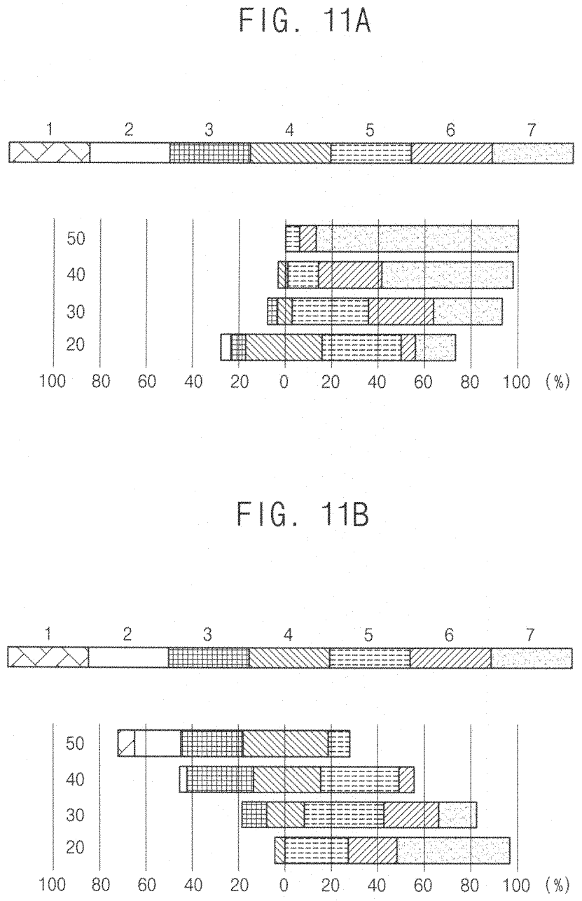

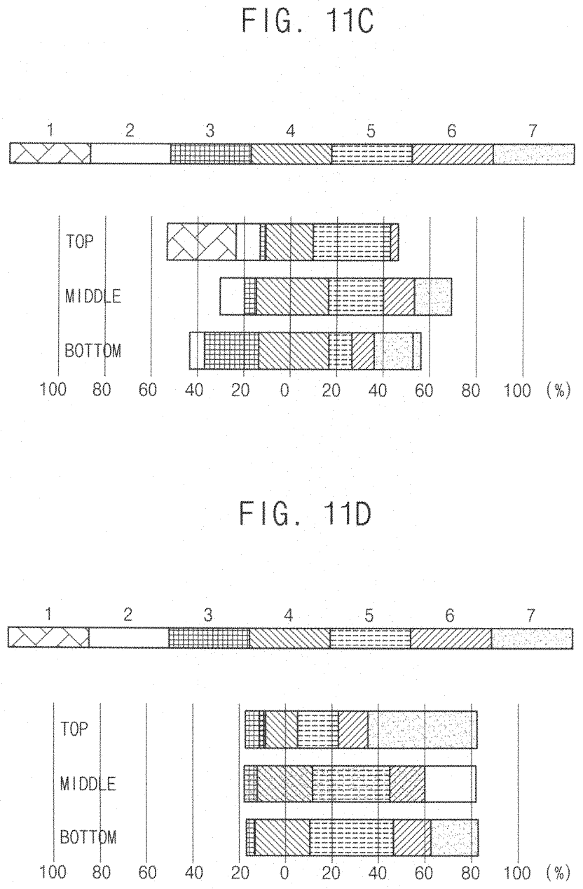

FIG. 11A is a graph illustrating perceptibility of the vibrator A2 of FIG. 1. FIG. 11B is a graph illustrating comfortability of the vibrator A2 of FIG. 1. FIG. 11C is a graph illustrating perceptibility of the LED A1 of FIG. 1. FIG. 11D is a graph illustrating comfortability of the LED A1 of FIG. 1

Referring to FIGS. 1 to 11D, the wearable apparatus provides appropriate feedback to users for effective guide of the 20-20-20 rule. To design proper feedback, the following issues may be addressed.

1) The feedback should be effective for users to recognize the notification well even while concentrating on some activities such as work and study. 2) The feedback should not be uncomfortable. 3) The feedback should support various modes of feedback so that users can distinguish different notification messages, i.e., for 20-minute screen viewing, for the completion of 20-second rest, and for the appropriate distance during a rest.

The wearable apparatus includes two types of actuators A1 and A2 for appropriate feedback. The actuators may include the vibrator A2 and the light emitting element A1.

The actuators A1 and A2 may be controlled to provide both for perceptibility and comfortability to the user. For example, in test conditions, vibration strength of the vibrator A2 may be set to 20, 30, 40 and 50. In test conditions, a position of the light emitting element A1 may be set to a top of a rim, a middle of the rim and a bottom of the rim.

In FIGS. 11A and 11C, for perceptibility, 1 means never perceptible and 7 means very well perceptible. In FIGS. 11B and 11D, for comfortability, 1 means very uncomfortable and 7 means never uncomfortable.

As shown in FIGS. 11A to 11D, the vibration is more perceptible but more uncomfortable as well, compared to LED light. The vibration strength 30 may be a balanced option for both of the metrics. While stronger vibration is very well perceptible, the user may feel uncomfortable due to strong vibration. For the LED light, all three options of the light emitting element A1 have similar comfortability. However, the middle and bottom positions of the light emitting element A1 may be good regarding perceptibility while the users were more positive about the middle position than the bottom position. The top position of the light emitting element A1 may not be a feasible option due to its low perceptibility. The vibration strength of the vibration A2 may be set to 30 or 20 and the position of the light emitting element A1 may be set to the middle position of the rim.

The feedback of the wearable apparatus may include a first feedback mode providing feedback for the 20 minutes of screen viewing, a second feedback mode providing feedback for the 20 feet of viewing distance during a break, and a third feedback mode providing feedback for the 20 seconds of break time.

The first feedback mode is necessary to lead a user to take a break after 20 minutes of screen viewing. In the first feedback mode, it is important to give feedback that a user can recognize certainly in this situation. Thus, in the first feedback mode, the perceptibility may be more significant than the comfortability. Therefore, in the first feedback mode, the vibrator A2 may be used.

For the second feedback mode, there are two main cases when a user sees something at the distance of (1) 20 feet or longer (a first case) or (2) shorter than 20 feet (a second case). In the second feedback mode, a user stops viewing a screen anyway so that high priority may be given to comfortability over perceptibility. Therefore, in the second feedback mode, the light emitting element A1 may be used. In the first case, the light emitting element A1 may emit a first color light (e.g. a green light). In the second case, the light emitting element A1 may emit a second color light (e.g. a red light).

In the third feedback mode, after a 20-second break, it is necessary to notify a user that the user succeeds in taking a break for 20 seconds so that the user can return to the user's previous activity. It is not required to strongly enforce a user to stop taking a break at once when the duration of a break reaches 20 seconds. Thus, in third feedback mode, the vibrator A2 may be used. The vibration of the third feedback mode may be weaker than the vibration of the first feedback mode.

According to the present example embodiment, the wearable apparatus monitors the user's screen viewing activities and helping the user follow the 20-20-20 rule to alleviate the user's computer vision syndrome.

The wearable apparatus and the system for alleviating computer vision syndrome include the color sensor, the inertial sensor and the distance measurement sensor so that the user's screen viewing activities may be accurately monitored. In addition, the wearable apparatus and the system for alleviating computer vision syndrome may provide real-time feedback to help the user follow the 20-20-20 rule.

In addition, the system for alleviating computer vision syndrome may provide a retrospective summary which shows how well the user followed the 20-20-20 rule via a mobile application.

According to the present inventive concept as explained above, the user's screen viewing activities may be monitored and the feedback may be provided to the user so that the user's computer vision syndrome may be alleviated.

The foregoing is illustrative of the present inventive concept and is not to be construed as limiting thereof. Although a few example embodiments of the present inventive concept have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the appended claims. The present inventive concept is defined by the following claims, with equivalents of the claims to be included therein.

What is claimed is:

1. A wearable apparatus comprising:
a plurality of sensors configured to sense a user's screen viewing activity;
a plurality of actuators configured to provide a plurality of feedbacks to the user according to the sensed user's screen viewing activity; and
a controller configured to receive sensed data including the sensed user's screen viewing activity from the plurality of sensors and configured to operate the plurality of actuators based on the received sensed data.

2. The wearable apparatus of claim 1, wherein the controller comprises:
a sensor manager configured to receive the sensed data from the plurality of sensors and configured to extract a feature from the received sensed data;
an actuator manager configured to control operations of the plurality of actuators based on the received sensed data;
a screen viewing detector configured to detect whether the user is viewing a screen or not based on the received sensed data; and
an eye-resting detector configured to measure a viewing distance of the user based on the received sensed data to determine whether the viewing distance of the user is equal to or greater than a reference viewing distance in an eye-resting session.

3. The wearable apparatus of claim 2, wherein the screen viewing detector is configured to operate a multisensory fusion operation using the received sensed data received from the plurality of sensors.

4. The wearable apparatus of claim 3, further comprising a database configured to store the user's screen viewing activity.

5. The wearable apparatus of claim 3, wherein the plurality of sensors comprises a color sensor, an inertial sensor and a distance measurement sensor.

6. The wearable apparatus of claim 5, wherein the sensed data from at least two sensors among the color sensor, the inertial sensor and the distance measurement sensor are combined.

7. The wearable apparatus of claim 6, wherein the wearable apparatus is configured to extract sensor specific features of the color sensor, the inertial sensor and the distance measurement sensor separately, to concatenate the sensor specific features in a feature level, to normalize the sensor specific features to standardize a range of the sensor specific features and to apply for a principal component analysis (PCA) to the normalized sensor specific features to reduce input dimensions, and wherein the wearable apparatus is configured to use a support vector machine (SVM) as a unified classifier for the color sensor, the inertial sensor and the distance measurement sensor.

8. The wearable apparatus of claim 2, wherein the plurality of actuators comprise a vibrator and a light emitting element.

9. The wearable apparatus of claim 8, wherein the plurality of actuators are configured to operate in a first feedback mode, a second feedback mode and a third feedback mode.

10. The wearable apparatus of claim 9, wherein the vibrator is configured to operate in the first feedback mode,
wherein the light emitting element is configured to generate a first color light and a second color light in the second feedback mode,
wherein the vibrator is configured to operate in the third feedback mode, and
wherein vibration of the vibrator in the third feedback mode is weaker than vibration of the vibrator in the first feedback mode.

11. A system for alleviating computer vision syndrome, the system comprising:
a wearable apparatus; and
a mobile application configured to provide a retrospective summary representing whether a user follows a 20-20-20 rule,
wherein the wearable apparatus comprises:
a plurality of sensors configured to sense a user's screen viewing activity;
a plurality of actuators configured to provide a plurality of feedbacks to the user according to the sensed user's screen viewing activity; and
a controller configured to receive sensed data including the sensed user's screen viewing activity from the plurality of sensors and configured to operate the plurality of actuators based on the received sensed data.

12. The system of claim 11, wherein the mobile application is configured to provide a user's daily screen viewing time, a user's weekly screen viewing time, a user's monthly screen viewing time and a user's yearly screen viewing time, and
wherein the mobile application is configured to provide a first number which is a number of screen viewing more than 20 minutes and a second number which is a number of taking a 20 second break to view objects 20 feet away following the 20-20-20 rule.

13. A wearable apparatus comprises:
an eyeglass frame;
a plurality of sensors disposed on the eyeglass frame;
a plurality of actuators disposed on the eyeglass frame and configured to provide a plurality of feedbacks; and
a processor disposed on the eyeglass frame and configured to control the plurality of sensors and the plurality of actuators.

14. The wearable apparatus of claim 13, wherein the plurality of sensors comprises a color sensor, an inertial sensor and a distance measurement sensor.

15. The wearable apparatus of claim 14, wherein the color sensor and the distance measurement sensor are disposed on a bridge of the eyeglass frame between a left lens and a right lens.

16. The wearable apparatus of claim 14, wherein the actuators comprise a vibrator and a light emitting element.

17. The wearable apparatus of claim 16, wherein the vibrator is disposed on temple of the eyeglass frame, and
wherein the light emitting element is disposed on a left lens rim or a right lens rim.

18. A system for alleviating computer vision syndrome, the system comprising:
a wearable apparatus; and
a mobile application configured to provide a retrospective summary representing whether a user follows a 20-20-20 rule,
wherein the wearable apparatus comprises:
an eyeglass frame;
a plurality of sensors disposed on the eyeglass frame;
a plurality of actuators disposed on the eyeglass frame and configured to provide a plurality of feedbacks; and
a processor disposed on the eyeglass frame and configured to control the plurality of sensors and the plurality of actuators.

19. The system of claim 18, wherein the mobile application is configured to provide a user's daily screen viewing time, a user's weekly screen viewing time, a user's monthly screen viewing time and a user's yearly screen viewing time, and
wherein the mobile application is configured to provide a first number which is a number of screen viewing more than 20 minutes and a second number which is a number of taking a 20 second break to view objects 20 feet away following the 20-20-20 rule.
